(19) United States
(12) Patent Application Publication
(10) Pub. No.: US 2005/0131874 A1
(43) Pub. Date: Jun. 16, 2005

(54) Method and system for obtaining solutions to contradictional problems from a semantically indexed database

(76) Inventor: Mikhail Verbitsky, Stoughton, MA (US)

Correspondence Address: Lawrence S. Cohen, Suite 830, 10960 Wilshire Boulevard, Los Angeles, CA, 90024, US

(21) Appl. No.: 10/737,147

(22) Filed: Dec. 15, 2003

(51) Int. Cl. G06F 17/30

(52) U.S. Cl. 707/3

(57) ABSTRACT

Solutions to engineering or other problems are obtained by expressing a problem in terms of a natural language query that contains a contradiction and submitting the query to a semantically indexed database. The database will search based on the semantic items that form, respectively, each side of the contradiction and will provide the search results to the user.

### BACKGROUND OF THE INVENTION

The process of innovation within organizations remains largely untouched by the general trend toward improved efficiency through automation. The traditional model of stimulating innovative thought is through the application of psychological techniques such as brainstorming. The techniques bring limited improvement to the process.

More recently, there have emerged a number of computer-based technologies that can be applied by a researcher or designer who is considering the creation or improvement of a device, process, or other system. These technologies can be defined as problem analysis and problem solving tools.

Problem analysis and problem solving tools assist the user by enabling the user to consider a complex system, and identify discrete problems which should be addressed, and suggest possible solutions. These tools accomplish this by providing computer based interfaces which assist in the application of well understood methods of problem analysis and problem solving including, but are not limited to, root cause analysis, TRIZ, value engineering, function analysis, and system benchmarking. An example of such a tool, called TechOptimizer, is Massachusetts. The technology used in TechOptimizer to assist in problem analysis is partially described in U.S. Pat. No. 6,056,428 and U.S. Pat. No. 6,202,043. The system disclosed in these two patents is fully described in TechOptimizer User Guide, version 4.0, Invention Machine Corporation, Boston, Mass. A natural language query and a semantically indexed database are described in U.S. Pat. No. 6,167,370 issued Dec. 26, 2000 and involve the restatement of queries as well as the database indexing in terms of subject-action-object (SAO) in order to obtain only relevant responses from the search and for evaluating the appropriateness of the responses.

The TechOptimizer software suite includes a database of principles that are useful in solving engineering problems and graphics and associated text that illustrate how those principles had been used in the past to solve similar engineering problems. A user of TechOptimizer software initially has to express a problem as a contradiction by selecting appropriate improving and worsening features from a prescribed list of generic features in order to converge on a suitable contradiction statement and the software responds by suggesting one or more principles that are provided in the software as possible approaches to a solution. The user then selects a principle and the system brings up graphics and text to illustrate various implementations of the selected principle.

A user of TechOptimizer software initially has to find the improving and worsening features from the prescribed list of generic features in order to converge on a suitable contradiction. In addition, the system response is limited to forty inventive principles from a table of contradictions as well as few hundred examples of graphics and text suggestions.

Referring to FIG. 1 there is shown the prior art as incorporated in the TechOptimizer product. As an example to illustrate the steps in FIG. 1 the problem is to improve a design by increasing the area of one of the design components. When this proposed improvement is implemented, it is realized that an undesirable consequence of the area increase is increase in the volume of the design. The designer would like to avoid the undesirable consequence. If the designer were looking for assistance from a commercially available system (TechOptimizer), he would follow the steps described in FIGS. 1-2. In step (1) the user formulates a contradiction by following the prompts “I want to” entering “improve my design”, “by” entering “increasing area”, and “but there is a problem” entering “increasing volume”. This is displayed to aid in the following steps. In step (2) the user submits this contradiction into the system. He does this by selecting from the list of “Improving feature” the one that most closely fits the desired improvement and from the list of “Worsening feature” the one that most closely fits the problem. The matrix has 39 specified improvement features and 39 specified worsening features (for example, an improvement feature, the area of a moving object and a worsening feature, the volume of a moving object). In step (3) the software responds by suggesting one or more of the principles that have been included in the program as possible approaches to a solution. The user then selects a principle and the system brings up graphics and text that have been included in the software to illustrate various implementations of the selected principle.

The prior art system for automating and aiding the solution of such problems has the shortcoming that it is limited in the availability of contradiction variables by the matrix of contradictions, a 39 by 39 item matrix. It is further limited in that the Principles are limited in number. Consequently, the user must select the nearest items in the matrix of contradictions, which may or may not be truly on point. In addition the proposed solutions are really only general engineering principles, and in any case are limited to those included in the software.

### SUMMARY OF THE INVENTION

In accordance with the principles of this invention, a problem analysis and problem solving tool (that is a problem analysis and problem solving program operational through a computer) is constructed to allow entering of a natural language query in contradictional form and to submit the natural language query in contradictional form to a semantically indexed database for searching. The invention is based on the realization that obtaining search responses to queries in terms of a contradiction is very much facilitated by formulating a contradiction as a natural language question and by using that natural language question to query a semantically-indexed database of possible problem solutions. The responses from the submitted query will contain subject matter that refers to both parts of the contradiction. This will directly lead to proposed solutions that are more relevant and that are more detailed.

The invention is useful for any problem that can be constructed as a contradiction in which each element of the contradiction has at least two semantic items; and in which the contradiction is converted to a natural language query. This includes for example, engineering problems, science problems, business problems, and financial problems.

In one aspect the invention is a method and a system that for obtaining solution suggestions for contradictional problems. It is performed using a program in a computer beginning with inputting a natural language query which is a restatement of a contradiction having at least two contradictional elements and having at least two semantic items as part of each contradictional element. The natural language query is then submitted to one or more semantically indexed databases and responses from the database(s) is/are communicated to the computer and the results then made available to the user by an output device.

In a particular aspect of the invention a selected database is a semantically indexed patent collection.

In a further aspect of the invention the natural language query can be combined with a specific search criterion.

In a further aspect of the invention a specif search criterion is combined with the natural language query and corresponding recurrent responses create dependence of the search results to the specific criterion based on variation in the search results to the recurrent different specific criteria.

In further aspects of the invention various exemplary specific search criteria are, time intervals, dates, an organization, a geographical description an industrial category.

In further aspects of the invention various specific recurrent criteria are different time periods such as adjacent time periods or different particular dates, different geographical areas, different industrial organizations different industrial categories.

### BRIEF DESCRIPTION OF THE DRAWINGS

FIG. 1 is a flow diagram of the commercially available system and method for solving contradictional engineering problems;

FIG. 2 is an illustrative screen for a search query and for a search response in the commercially available system and by a method for solving engineering problems;

FIG. 3 is a flow diagram of a system and by a method in accordance with the principles of this invention; and

FIG. 4 is an illustrative screen for a search query and for a search response in a system and by a method in accordance with the principles of this invention.

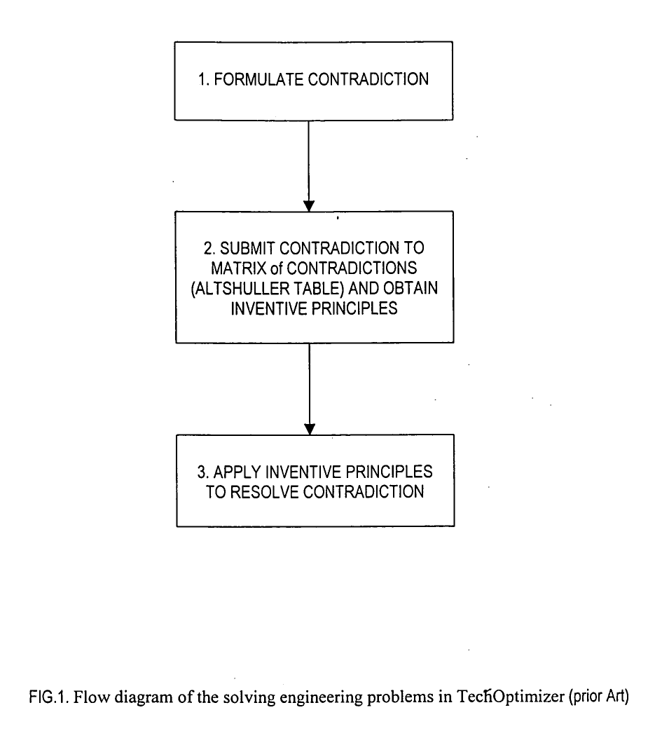

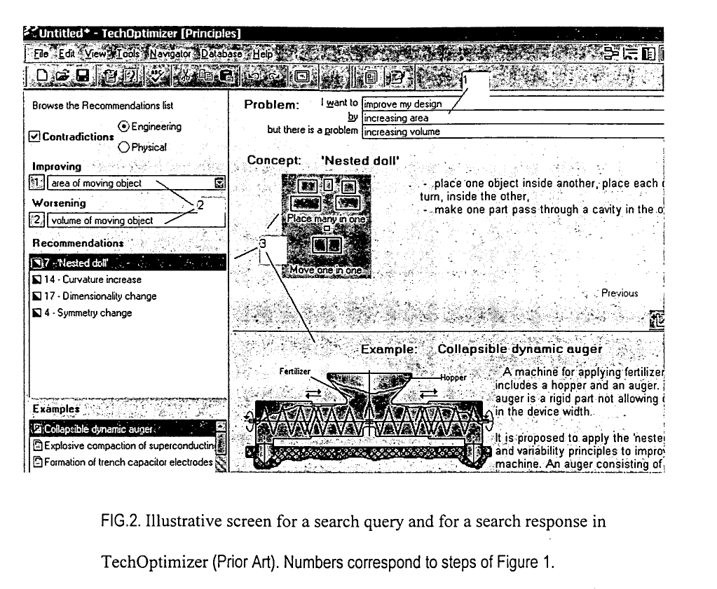

### DETAILED DESCRIPTION

The present invention is described herein as required by 35 U.S.C. 112. The invention is intended to be embodied in a software program storable in a computer readable storage medium. A user will have access to use the program through interaction with screens presented on a monitor. The screens will among other things allow the user to input material and activate the various actions to be performed by the program. It is also a capability of the program to automatically perform some steps; or to perform steps upon command; or to allow user input before performing various steps. The results obtained from use of the program will be displayable on a monitor, or may be available through other known output means such as a printer.

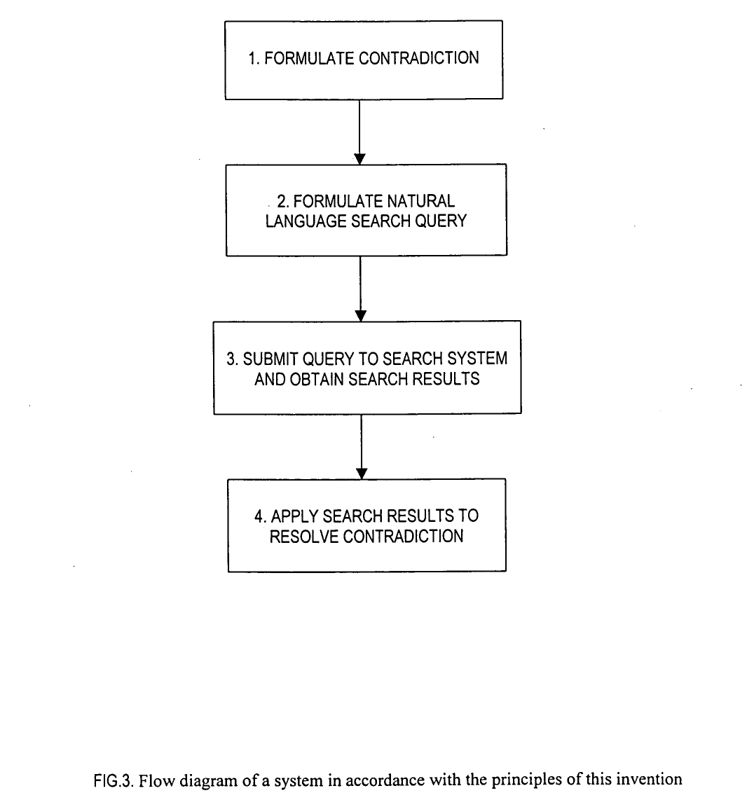

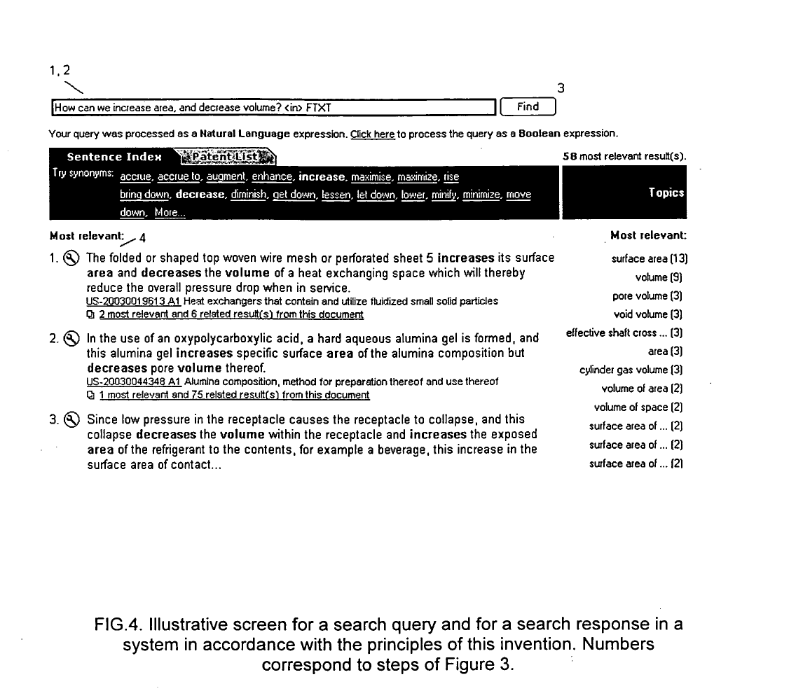

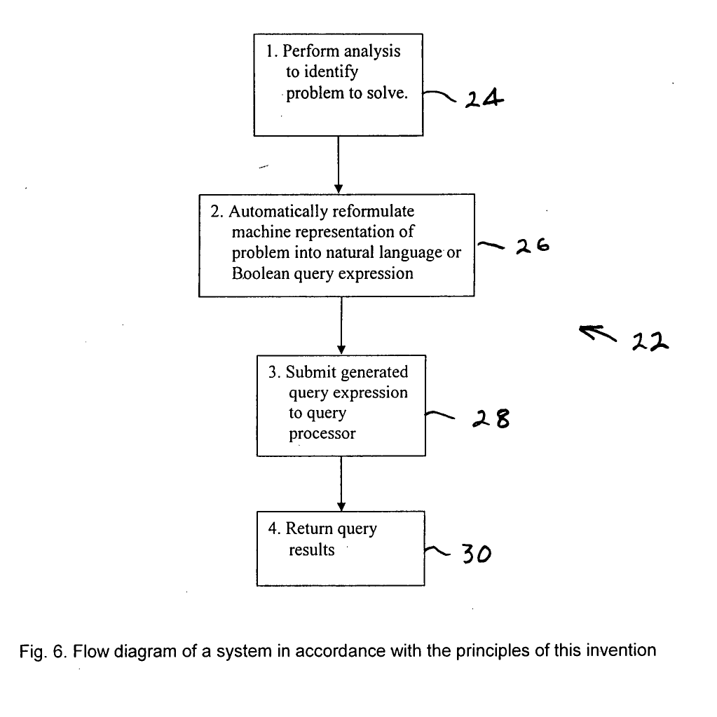

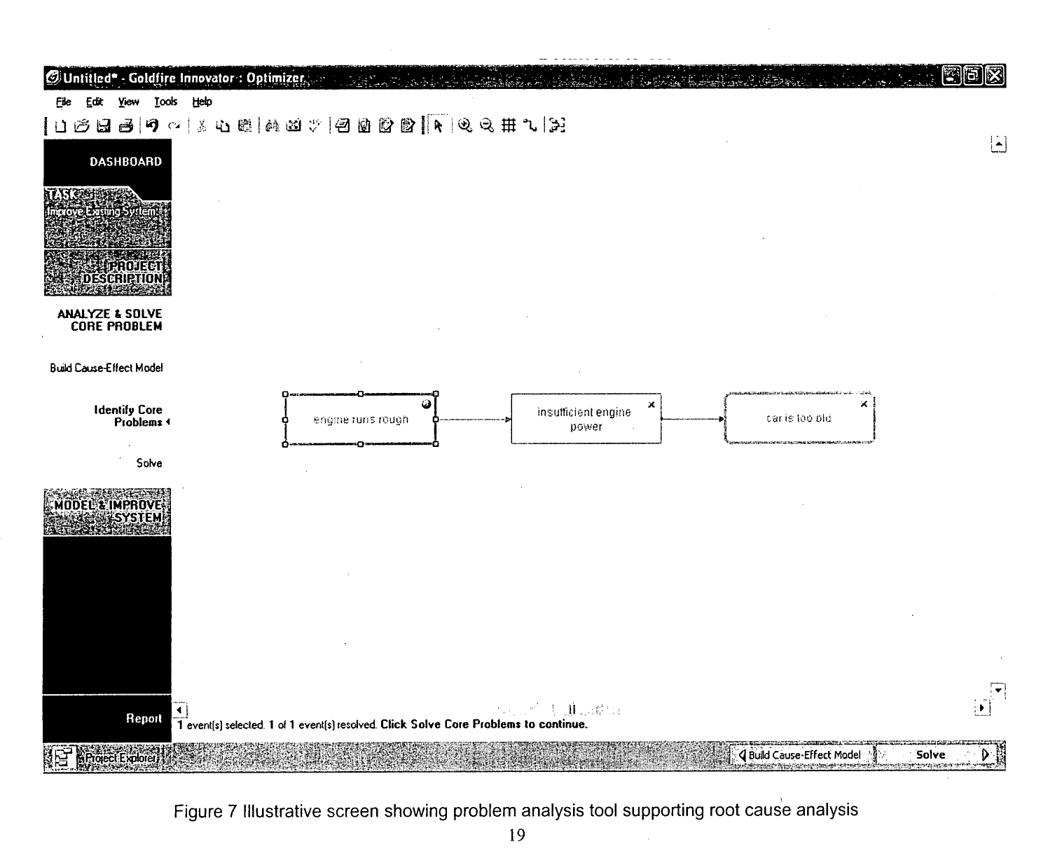

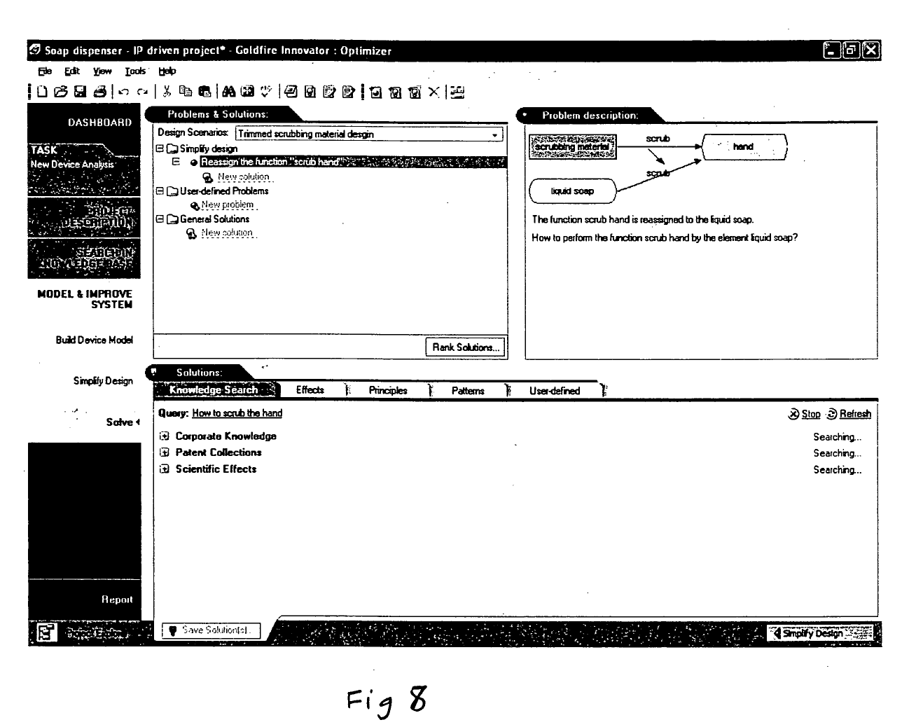

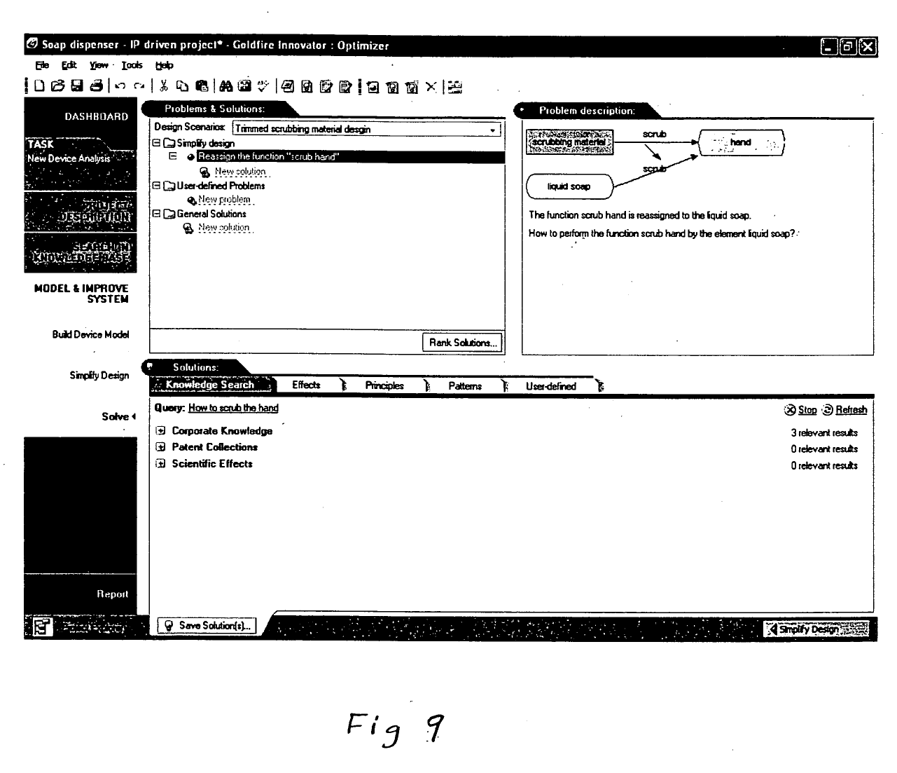

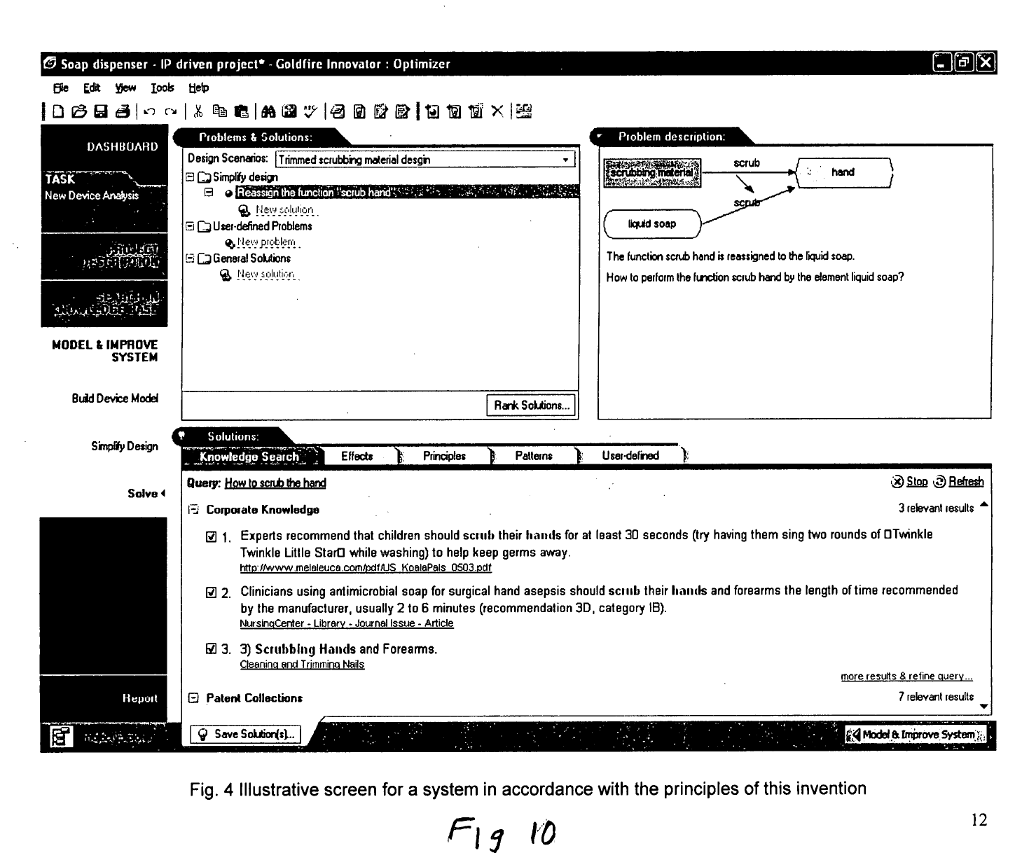

With the system and method of the present invention, a user would follow the steps described in FIGS. 3-4. The contradiction may be formulated in any desired way, using a matrix of preselected improving and worsening features or by deciding without being limited on the best, most specific statements for improving and worsening features. A contradiction is a circumstance in which an improving feature causes a worsening feature. The user then constructs a natural language statement that contains the contradiction features. The user then inputs into the computer the natural language form of the contradiction as a natural language contradictional query. Alternatively, the program may have a module that automatically formulates the natural language query. The program then implements either automatically or upon further command from the user searching of one or more specified available databases that are semantically indexed. By definition herein the term semantically indexed database is one that recognizes the semantic role of a word in the text and therefore can be searched by a query that contains one or more contradictional elements in which each contradictional element has at least two semantic items and that will search for the semantic items in each of the contradictional elements. For purposes of this description the semantic items in each contradictional element are defined as a set of semantic items. In the case of a query, such as a natural language contradictional query that contains a set having two or more semantic items in each contradictional element, the search will find content in the database that contains both sets of the semantic items. The search provides possible solutions by matching semantic items in the query with semantic items in the semantically indexed database. As described in the aforementioned U.S. Pat. No. 6,167,370, semantic items have the semantic designations, subject (S), action (A) and object (O).

A query properly constructed for searching will have an improving statement and a worsening statement, which being in conflict constitute a contradiction. The basic contradiction for a query to search a semantically indexed database has one improving statement and one worsening statement; but as will be seen below the concepts of the invention are not limited to a single improving statement and a single worsening statement.

The solutions to search of a semantically indexed database can be provided to a user using known outputs such as a monitor, a printer, or audio or using recording media such as CD or tape or disc. The output can be saved on the computer or on any media available for storing it.

Referring to FIG. 3 the steps of the method are:

1. Formulate a contradiction;

2. Formulate a natural language query that contains the contradiction and includes a set of semantic items in each contradiction element;

3. Submit the query to a search system that has access to a semantically indexed database;

4. Apply the search results to resolve the contradiction.

The step of formulating a natural language query may be input by the user or it may be automated by a program module that formulates it from the contradiction.

As shown in FIG. 4, the search results are displayed on a monitor. The particular search results shown are from a proprietary database of a patent collection that is semantically indexed.

In the example shown in FIG. 4, the contradiction is to increase area and decrease volume. The contradiction has been reformulated by the user as the natural language query “How can we increase area, and decrease volume”. The improving contradictional element is “How can we increase area”. It contains a semantic set consisting of the semantic item “increase” which is an action or A semantic item and the semantic item “area” which is an object or O semantic item. The worsening contradictional element is “and decrease volume”. It contains a semantic set consisting of the semantic item “decrease” which is an action or A semantic item and “volume” which is an object or O semantic item. This natural language contradictional query is inputted into a window at 1, 2 and the user clicks on “find” at 3, which activates the search. The semantically indexed database may be accessible in any number of known ways. For example, it may be stored on the user's own desktop computer; it may be accessible on a corporate server (the term “corporate” is used here to designate any institution or organization that has a network with a server available to users within it, such as a business, a university, a government agency, etc.) or it may be accessible via the internet. Upon activating the search, the searching source performs a comparison of semantic items in the query with the semantically indexed database. In the example of FIGS. 3 and 4, the search of the semantically-indexed patent database displays fragments of content of patents found that have both sides of the contradiction, that is both of the semantic items in each semantic set in the query, along with the patent number. The items searched for are in bold type. The patent number is highlighted so that it can be “clicked” to go to the database and retrieve and display the patent by way of a link to the database. It can be printed or saved. Typically the user will first examine the fragments and will open those that seem to be most relevant in order to obtain possible solutions to the contradiction; which then can be applied to the particular problem at hand.

The above examples use two semantic items for each side of a contradiction (“increase” and “area” on one side and “decrease” and “volume” on the other side), more complex queries such as “How can we decrease the area of the contact without increasing the weight because the weight can jeopardize the design reliability” can be searched in more sophisticated semantically-indexed database. In this example a single improving condition or statement is “How can we decrease the area” in which the semantic set consists of “decrease” which is an action or A semantic item and “the area of contact” which is an object or O semantic item. This example has two worsening conditions or statements. The first is “without increasing the weight” in which the semantic set consists of “increasing” which is an action or A semantic item and “weight” which is an object or O semantic item. The second worsening condition or statement in this case is functionally related to the first worsening statement, “because the weight can jeopardize the design reliability” in which the semantic set consists of “weight” a subject or S semantic item and “jeopardize” which is an action or O semantic item and “design reliability” which is an object or O semantic item.

Another example of a more complex contradiction, also having three contradictional elements is given as “How can we decrease the area of the contact without increasing the weight and preserving the current transparency”. In this example there is still a single improving condition or statement and two worsening conditions or statements. But in this example the worsening conditions are functionally not related (although they may be interdependent). The improving condition “How can we decrease the area” and the worsening condition “without increasing the weight” have in their respective semantic sets the semantic items as given above. The contradictional element “preserving the current transparency” has in its semantic set the semantic item “preserving” which is an action or A semantic item and “current transparency” which is an object or O semantic item.

It can be easily anticipated that the process described above and illustrated in FIGS. 3 and 4 can be combined with traditional search criteria like key-word search, Boolean logic, and so on. For example, the contradictional query ‘how can we increase area, and decrease volume’ submitted to semantically indexed database representing semantically indexed patent collection, can be combined with the request that responses should arrive only from patents satisfying specific one or criterion, like a specific key word in a patent title or abstract, or they have to belong to a specific patent class, or starting from or up to a specific issue or filing date, or extending over a specific time period (by issue date or filing date) . Other desired specific criteria are also possible. The full query therefore will look like in the following examples:
(1) ‘How can we increase area, and decrease volume?’

AND

<<‘fiber’> in patent title OR <‘fiber’> in patent abstract>;
(2) ‘How can we increase area, and decrease volume?’

AND

<application date is between 1975 and 1980>;
(3) ‘How can we increase area, and decrease volume?’

AND

<<Shell > in Assignee name>

If we ask this question recurrently by changing a selected additional search criterion, there will be a dependence of results on this criterion. For example, if we ask the question

‘How can we increase area, and decrease volume?’

AND

<application date is between 1975 and 1980>

recurrently, changing the application date time interval, we will observe how the solution to our contradictional problem evolved in time. Other additional criteria that may be searched recurrently can be used such as different assignees of patents, patent classes or any varying criterion that can be used for comparing the results.

As herein described the present invention is an improvement over a problem analysis and problem solving tool that allows only the use of a limited matrix of contradictions and of a limited number of solution Principles because it allows access to and searching of any semantically indexed database.

Attached hereto as APPENDIX A is a patent application entitled METHOD FOR PROBLEM FORMULATION AND FOR OBTAINING SOLUTIONS FROM A DATABASE of James Todhunter, the content of which is incorporated herein by reference or by reason of this attachment.

Attached hereto as APPENDIX B is a paper entitled Semantic TRIZ™ by Mikhail Verbitsky, the content of which is incorporated herein by reference or by reason of this attachment.

It will be understood that various modifications and changes can be made to the herein disclosed examples without departing from the spirit and scope of the present invention which is defined by the claims and equivalents thereof.

1. A method of obtaining solution suggestions for contradictional problems using a specially programmed computer having two-way access to at least one semantically-indexed database and having at least one user accessible output device comprising the steps of;
inputting into the specially programmed computer a natural language query which is a restatement of a contradiction having at least two contradictional elements and having at least two semantic items as part of each contradictional element;
submitting the natural language query to at least one semantically indexed database which is accessible by the computer;
causing responses from the search of the database to be communicated to the computer; and
providing from the computer to an output device the responses from the search of the database.

2. The method of claim 1 in which the semantically indexed database is a semantically indexed patent collection.

3. The method of claim 1 in which the natural language query is submitted to search a semantically indexed database, the natural language query being combined with a specific search criterion.

4. The method of claim 1 in which the natural language query is submitted recurrently to different parts of the semantically indexed database, the parts of the semantically indexed database being selected according to a specific criterion which is combined with the natural language query, and corresponding recurrent responses create dependence of the search results to the specific criterion whereby variation in the search results to the recurrent different specific criteria may be determined.

5. The method of claim 3 in which the specific search criterion is a time interval.

6. The method of claim 3 in which the specific search criterion is a defined type of organization.

7. The method of claim 3 in which the specific search criterion is a geographical description.

8. The method of claim 4 in which the different specific criteria are different time periods or different particular times.

9. The method of claim 4 in which the different specific criteria are different geographical areas.

10. The method of claim 6 in which the defined type of organization is an industrial designation.

11. The method of claim 6 in which the defined type of organization is an institutional designation.

12. A system for obtaining solution suggestions for contradictional problems, said system comprising;
a specially programmed computer having an input device and at least one output device;
said program having an element enabling inputting into the program a natural language query as a restatement of a contradiction said contradiction having at least two contradictional elements and having at least two semantic items as part of each contradictional element;
at least one semantically indexed database accessible by the program;
an element of said program enabling submission of said natural language query to said at least one semantically indexed database to execute a search; and
an element of the program providing access to the responses from the search by the output device to a user.

13. The system as in claim 12 in which the semantically indexed database is a semantically indexed patent collection.

14. The system of claim 12 in which the natural language query is submitted to search a semantically indexed database, the natural language query being combined with a specific search criterion.

15. The system of claim 12 in which the natural language query is submitted recurrently to different parts of the semantically indexed database, the parts of the semantically indexed database being selected according to a specific criterion which is combined with the natural language query, and corresponding recurrent responses create dependence of the search results to the specific criterion whereby variation in the search results to the recurrent different specific criteria may be determined.

16. The system of claim 14 in which the specific search criterion is a time interval.

17. The system of claim 14 in which the specific search criterion is a defined type of organization.

18. The system of claim 14 in which the specific search criterion is a geographical description.

19. The system of claim 15 in which the different specific criteria are different time periods or different particular times.

20. The system of claim 15 in which the different specific criteria are different geographical areas.

21. The system of claim 17 in which the defined type of organization is an industrial designation.

22. The system of claim 17 in which the defined type of organization is an institutional designation.

23. A method of obtaining solution suggestions for contradictional problems using a specially programmed computer having two-way access to at least one semantically indexed database and having at least one user accessible output device comprising the steps of;
formulating by a portion of the computer program a natural language query as a restatement of a contradiction having at least two contradictional elements and having at least two semantic items as part of each contradictory element;
submitting the natural language query to at least one semantically indexed database which is accessible by the computer;
causing responses from the search of the database to be communicated to the computer; and
providing from the computer to an output device the responses from the search of the database.

24. The method of claim 23 in which the semantically indexed database is a semantically indexed patent collection.

25. The method of claim 23 in which the natural language query is submitted to search a semantically indexed database, the natural language query being combined with a specific search criteria.

26. The method of claim 23 in which the natural language query is submitted recurrently to different parts of the semantically indexed database, the parts of the semantically indexed database being selected according to a specific criterion which is combined with the natural language query, and corresponding recurrent responses create dependence of the search results to the specific criteria whereby variation in the search results to the recurrent different specific criteria may be determined.

27. The method of claim 25 in which the specific search criterion is a time interval.

28. The method of claim 25 in which the specific search criterion is a defined type of organization.

29. The method of claim 25 in which the specific search criterion is a geographical description.

30. The method of claim 26 in which the different specific criteria are different time periods or different particular times.

31. The method of claim 26 in which the different specific criteria are different geographical areas.

32. The method of claim 28 in which the defined type of organization is an industrial designation.

33. The method of claim 28 in which the defined type of organization is an institutional designation.

34. A system for obtaining solution suggestions for contradictional problems, said system comprising;
a computer specially programmed for formulating a natural language query as a restatement of a contradiction said contradiction having at least two contradictional elements and having at least two semantic items as part of each contradictional element;
an element having a semantically indexed database or access to a semantically indexed database;
said computer being programmed to enable submission of said natural language query to said semantically indexed database to execute a search; and
means for providing access to the results of the search to a user.

35. The system as in claim 34 in which the semantically indexed database is a semantically indexed patent collection.

36. The system of claim 34 in which the natural language query is submitted to search a semantically indexed database, the natural language query being combined with a specific search criterion.

37. The system of claim 34 in which the natural language query is submitted recurrently to different parts of the semantically indexed database, the parts of the semantically indexed database being selected according to a specific criterion which is combined with the natural language query, and corresponding recurrent responses create dependence of the search results to the specific criterion whereby variation in the search results to the recurrent different specific criteria may be determined.

38. The system of claim 36 in which the specific search criterion is a time interval.

39. The system of claim 36 in which the specific search criterion is a defined type of organization.

40. The system of 36 in which the specific search criterion is a geographical description.

41. The system of claim 37 in which the different specific criteria are different time periods or different particular times.

42. The system of claim 37 in which the different specific criteria are different geographical areas.

43. The system of claim 39 in which the defined type of organization is an industrial designation.

44. The system of claim 39 in which the defined type of organization is an institutional designation.
